(19) United States
(12) Patent Application Publication
(10) Pub. No.: US 2024/0053464 A1
(43) Pub. Date: Feb. 15, 2024

(54) Radar Detection and Tracking

(71) Applicant: The University of Bristol, Bristol (GB)

(72) Inventors: Naim Dahnoun, Bristol (GB); Han Cui, Bristol (GB)

(21) Appl. No.: 18/268,206

(22) PCT Filed: Dec. 18, 2021
(86) PCT No.: PCT/IB2021/061986

§ 371 Date: Jun. 16, 2023

(30) Foreign Application Priority Data
Dec. 18, 2020 (GB) 2020193.5
Jul. 20, 2021 (GB) 2110432.8

(51) Int. Cl. G01S 13/72; G01S 7/41; G01S 13/87; G01S 13/48; G01S 7/295

(52) U.S. Cl. CPC G01S 13/72; G01S 7/417; G01S 13/878; G01S 13/48; G01S 7/2955; G01S 7/415

(57) ABSTRACT

A system (100) for subject (50) detection is disclosed. The system (100) comprises a plurality of radar systems (21, 31). Each radar system (21, 31) comprises an antenna configured to transmit an electromagnetic signal and to detect reflections of the electromagnetic signal and determine a plurality of data points corresponding with the position of reflectors. The system also comprises a processor (10) configured to receive the plurality of data points from each radar system (21. 31), and to process the data points to detect and/or track a subject (50) therefrom. Each of the radar systems (21, 31) has a boresight (22, 32), corresponding with an axis of maximum antenna gain for the electromagnetic signal. The plurality of radar systems (21, 31) comprises a first radar system (21) with a first boresight (22) and a second radar system (31) with a second boresight (32). The first boresight (22) is at an angle of at least 25 degrees to the second boresight (32).

### TECHNICAL FIELD

The present invention relates to a method of detecting and/or tracking a subject using radar, and apparatus for radar detection and/or tracking of a subject.

### BACKGROUND

Detection and/or tracking of subjects is useful in a range of contexts, including social care, healthcare and security. Optical cameras can be used to detect and track subjects (e.g. human subjects), but privacy is a problem in such tracking. Subjects often are resistant to being recorded with an optical camera, for understandable reasons related to privacy.

Furthermore, optical cameras require visible illumination, which may not be available (for example in the night). One use case where a subject detection and tracking system is useful is in the context of detecting falls (e.g. prone subjects), and these may occur at night. In addition, optical cameras are not able to deal with obscuration, such as smoke.

A promising alternative to optical sensing is to use mmWave radar, which is now a relatively mature and low-cost technology.

Sengupta, Arindam, et al. “mm-Pose: Real-Time Human Skeletal Posture Estimation using mmWave Radars and CNNs.” IEEE Sensors Journal (2020) discloses real-time human posture estimation by applying machine learning to data obtained from mmWave radar.

Cui Han, and Naim Dahnoun. “Human Posture Capturing with Millimetre Wave Radars.” 2020 9th Mediterranean Conference on Embedded Computing (MECO). IEEE, 2020 discloses capturing human posture with a vertical radar array.

An improved apparatus and method for detecting and/or tracking a subject (or subjects) is desirable, and would have particular applications in care settings (e.g. geriatric care).

### SUMMARY

According to a first aspect, there is provided a system for subject detection, comprising:
a plurality of radar systems, each comprising an antenna and each radar system configured to: transmit an electromagnetic signal, detect reflections of the electromagnetic signal, and determine a plurality of data points corresponding with the position of reflectors;
a processor configured to receive the plurality of data points from each radar system, and to process the data points to detect and/or track a subject therefrom;
wherein:
   each of the radar systems has a boresight, corresponding with an axis of maximum antenna gain for the electromagnetic signal;
   the plurality of radar systems comprises a first radar system with a first boresight and a second radar system with a second boresight; and
   the first boresight is at an angle of at least 25 degrees to the second boresight.

In some embodiments of the first aspect, the first boresight may be parallel to the second boresight. The first radar system and the second radar system may be configured in a vertical array. The features described below and herein may be advantageous in the context of any subject detection system combining information from more than one radar system.

The subject may be a human or an animal. In some embodiments, the system may be configured to detect objects, rather than subjects. The system may be configured to detect multiple subjects (or objects) at the same time.

The first boresight and the second boresight may be at an angle of 25 degrees or less to a horizontal plane.

The first boresight and the second boresight may be at an angle of at least 45 degrees (or at least 60 degrees). The first radar system and the second radar system may be disposed in different positions (e.g. at least 0.5 m or 1 m apart). For example the first radar system may be coupled to and have a boresight normal to a first wall, and the second radar system may be coupled to and have a boresight normal to a second wall. The first and second wall may be at right angles to each other.

The plurality of radar systems may comprise a radar system with a boresight that is at an angle of less than 45 degrees with a vertical direction.

The system may further comprise a processor configured to:
receive data points from each of the plurality of radar systems;
for each radar system, define clusters of data points based on the distance between the data points.

The clusters may be defined from data points that are within a threshold distance from each other.

The threshold distance may be 20 cm or less, 15 cm or less, or 10 cm or less.

The processor may be configured to discard clusters that have fewer than a threshold number of data points.

The processor may be configured to:
transform the data points to a common coordinate system;
define verified clusters comprising clusters from different radar systems (e.g. the first and second radar systems) that sufficiently overlap in the common coordinate system.

The processor may be configured to classify a cluster as a subject based on whether the cluster is sufficiently similar to estimated (predicted) properties of the subject (e.g. volume, height, strength of return etc).

The processor may be configured to:
define a frame comprising data points from the plurality of radar systems with a common time;
clustering data points in each frame to define clusters;
associating clusters in different frames to define a track if a difference in the position of a cluster or group of clusters in different frames is less than a predefined threshold.

The term “common time” should not be construed as requiring that data points come from the same chirp. A common time may comprise a range of times (frame duration) that are within a threshold value of each other, for example less than 0.1 s, less than 50 ms, less than 20 ms or less than 10 ms.

The predefined threshold may be determined based on the frame duration and an expected velocity of a subject (e.g. <1 m/s).

A position of a cluster may be defined as the centroid of the data points that comprise the cluster.

The system may be configured to determine a pose for the subject.

Each of the radar systems may comprise a mmWave radar system. The electromagnetic signal may have a frequency of between 75 and 85 GHz.

At least some of the radar systems may be coupled to a displacement and/or rotation stage, which is configured to move and/or rotate the respective radar system, so as to change its location and/or boresight orientation. The processor may be configured to control the displacement and/or rotation stage in order to simulate additional radar systems.

Each radar system may comprise a plurality of antenna. There may be separate transmit and receive antennas There may be a plurality of transmit antennas and/or a plurality of receive antennas.

According to a second aspect, there is provided a method for subject detection, comprising:
using a plurality of radar systems, each comprising an antenna, to: transmit an electromagnetic signal, detect reflections of the electromagnetic signal and determine a plurality of data points corresponding with the position of reflectors;
receiving the plurality of data points from each radar system and processing the data points to detect and/or track a subject therefrom;
wherein:
   each of the radar systems has a boresight, corresponding with an axis of maximum antenna gain for the electromagnetic signal;
   the plurality of radar systems comprises a first radar system with a first boresight and a second radar system with a second boresight; and
   the first boresight is at an angle of at least 25 degrees to the second boresight.

In some embodiments of the second aspect, the first boresight may be parallel to the second boresight. The first radar system and the second radar system may be configured in a vertical array. The method steps defined below and herein may be advantageous in the context of any subject detection system combining information from more than one radar system.

The subject may be a human or an animal. In some embodiments, the method may comprise detecting objects, rather than subjects. The method may comprise detecting multiple subjects (or objects) at the same time.

The first boresight and the second boresight may be at an angle of 25 degrees or less to a horizontal plane; and/or the first boresight and the second boresight may be at an angle of at least 45 degrees.

The method may further comprise:
receiving data points from each of the plurality of radar systems;
for each radar system, defining clusters of data points comprising points that are within a threshold distance from each other.

The method may further comprise discarding clusters that have fewer than a threshold number of data points.

The method may comprise:
transforming the data points to a common coordinate system;
defining verified clusters comprising clusters from different radar systems that sufficiently overlap in the common coordinate system.

The method may comprise classifying a cluster as a subject based whether the cluster is sufficiently similar to estimated properties of the subject.

The method may comprise defining a frame comprising data points from the plurality of radar systems with a common time (i.e. within a frame time period);
clustering data points in each frame to define clusters;
associating clusters in different frames to define a track if a difference in the position of a cluster or group of clusters in different frames is less than a predefined threshold.

Clusters from different frames may be associated to define a track if a difference in the position and a difference in the size of a cluster or group of clusters in different frames is less than a predefined threshold.

A position of a cluster may be defined as the centroid of the data points that comprise the cluster.

The method may further comprise determining a pose for the subject.

The method may comprise moving and/or rotating at least some of the radar systems, so as to change its location and/or boresight orientation. The method may comprise using the processor to control the movement and/or rotation in order to simulate additional radar systems.

According to a third aspect, there is provided a method for determining the posture of a subject using a radar system, comprising:
using a radar system to: transmit an electromagnetic signal, detect reflections of the electromagnetic signal, and determine a plurality of data points corresponding with the position of reflectors;
processing the data points to determine the posture of a subject by:
   using a part detector to determine an estimate of a position of each of a plurality of joints; and
   using a spatial model to refine the estimate of the position of each of a plurality of joints;
wherein the spatial model encodes the expected relative positions between the plurality of joints.

The part detector may comprise a convolutional neural network that has been trained to determine the estimates of the positions of the joints.

The method may further comprise performing a temporal correlation operation to smooth the output from the spatial model.

The temporal correlation operation may comprise determining, for each estimated position of a joint: a confidence level, and a speed of movement. The temporal correlation operation may reject updated joint positions in response to the confidence level and/or the speed of movement.

The method may further comprise a step of determining at least a 2D image from the data points, and providing the 2D image as an input to the part detector.

The method according to the third aspect may use any of the features of the second aspect.

According to a fourth aspect, there is provided a method of training a system for posture recognition, wherein the system comprises:
a radar system that is configured to transmit an electromagnetic signal, detect reflections of the electromagnetic signal, and determine a plurality of data points corresponding with the position of reflectors;
a part detector for determining an estimate of position for a plurality of joints from the plurality of data points; and
a spatial model, for refining the estimate of the position of each of the plurality of joints from the part detector based on expected relative positions between the plurality of joints;
the method comprising:
   i) obtaining ground truth positions of the joints concurrently with detecting reflections of the electromagnetic signal with the radar system;
   ii) training the part detector to determine the estimate each joint position from the data points by minimising a first loss function determined with reference to the ground truth positions;
   iii) training the part detector to refine the estimate of each joint position from the part detector by minimising a second loss function determined with reference to the ground truth positions.

Step ii) and step iii) may be performed sequentially.

The training in steps i) and/or ii) may comprise performing a gradient descent method.

The training in steps i) and ii) may use a dynamic learning rate of between 10⁻² and 10⁻⁵. An optimiser that combines gradient descent with

According to a fifth aspect, there is provided a system for determining the posture of a subject using a radar system, comprising:
a radar system configured to: transmit an electromagnetic signal, detect reflections of the electromagnetic signal, and determine a plurality of data points corresponding with the position of reflectors;
a processor configured to process the data points to determine the posture of a subject by:
   using a part detector to determine an estimate of a position of each of a plurality of joints; and
   using a spatial model to refine the estimate of the position of each of a plurality of joints;
wherein the spatial model encodes the expected relative positions between the plurality of joints.

The fifth aspect may include any of the features of the first aspect.

The system may comprise a plurality of radar systems, each providing data points to the processor. The processor may be configured to use the data points from each radar system to determine the estimate of the position of each joint.

The part detector may comprise a convolutional neural network that has been trained to determine estimates for the positions of the joints.

The processor may be configured to perform a temporal correlation operation to smooth the output from the spatial model.

The temporal correlation operation may comprise determining, for each estimated position of a joint: a confidence level, and a speed of movement; wherein the temporal correlation operation rejects updated joint positions in response to the confidence level and/or the speed of movement.

The processor may be configured to determine a 2D image from the data points, and provide the 2D image as an input to the part detector.

The features of each aspect (including optional features) may be combined with those of any other aspect.

### BRIEF DESCRIPTION OF THE DRAWINGS

Example embodiments will be described, by way of example only, with reference to the drawings, in which:

FIG. 1 shows a plan view block diagram of a system according to an embodiment;

FIG. 2 shows an alternative view of the system of FIG. 1;

FIG. 3 is a block diagram of a signal processing chain for a radar system;

FIG. 4 is a block diagram of a software framework for processing data points from radar systems;

FIGS. 5 and 6 illustrate clustering of data points from a first radar system;

FIGS. 7 and 8 illustrate clustering of data points from a second radar system;

FIG. 9 illustrates verification of a cluster by correlation between clusters from the first and second radar systems;

FIG. 10 shows an example in which two subjects are detected;

FIG. 11 is a schematic showing tracking of subject movement;

FIG. 12 shows results obtained according to an embodiment in tracking a subject;

FIG. 13 shows how filtering can be applied to remove interference; and

FIG. 14 shows the effect of a second (interfering radar) on a first (main) radar, showing that this is generally not a problem.

### DETAILED DESCRIPTION

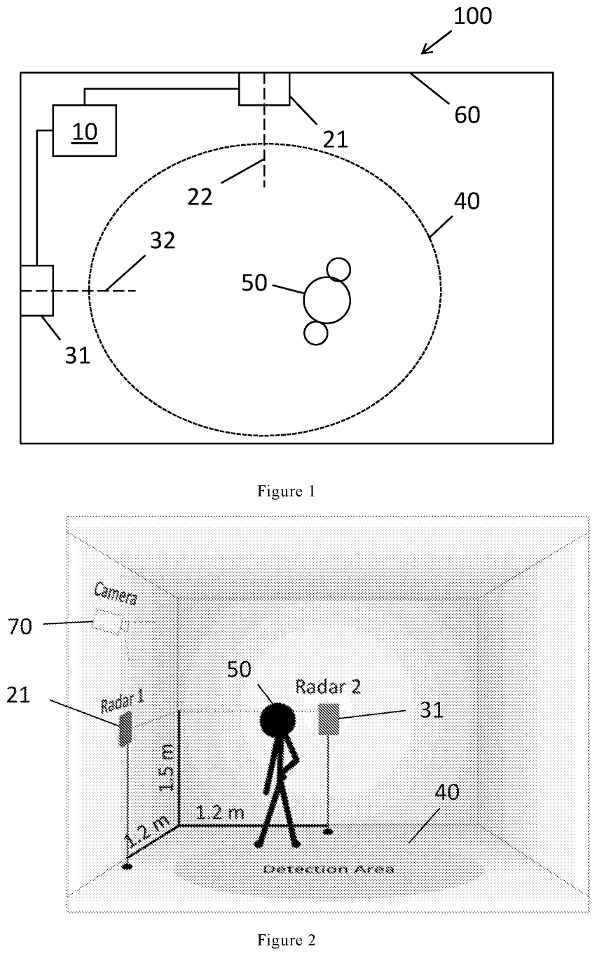

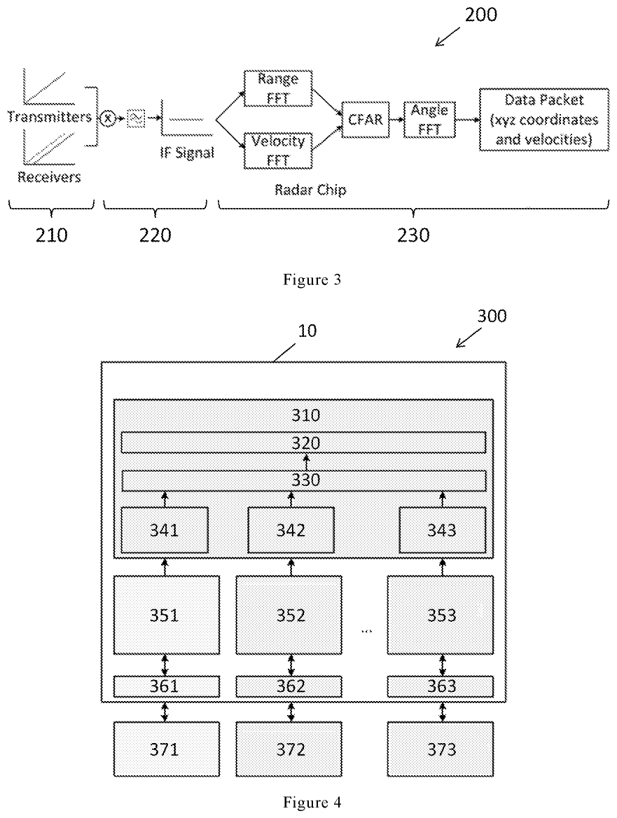

Referring to FIG. 1, a plan view block diagram of a system 100 according to an embodiment is shown, comprising: processor 10, first radar system 21, second radar system 31, and subject 50, within a room 60. FIG. 2 shows an alternative view of the system of FIG. 1, and further including a camera 70 (which may be used in some embodiments, but is not essential).

The subject (e.g. human) 50 is within the room 60, and the first radar system 21 and second radar system 31 are positioned to view a detection area 40 from different angles. In order to more accurately detect a subject, the first radar system 21 and second radar system 31 are placed at an angle to each other. More specifically, the boresight 22, 32 (which is defined as the direction of maximum antenna gain, and which defines the “pointing direction” of a radar system) of the first radar system 21 and the second radar system 31 are at approximately 90 degrees. The boresight 22, 32 of both the first and second radar system 21, 31 are also parallel to a horizontal plane.

In the example, the first radar system 21 is disposed on a first wall with a boresight normal to the first wall, and the second radar system 31 is disposed on a second wall with a boresight normal to the second wall. The first and second walls are at right angles to each other. The first radar system 21 and second radar system 31 may be at a height of between 1 m and 2 m (e.g. 1.5 m, as in this example) and separated in x and y directions (in plan) by at least 0.5 m (e.g. by 1.2 m, as in this example).

Although this arrangement has advantages which include ease of installation by attachment to different walls, other arrangements are possible. In some embodiments an array of radar systems may be provided at one or more of the locations or orientations of the first and second radar system 21, 31. In some embodiments a radar system may be provided with a boresight direction having a vertical component (e.g. looking down over a room from a corner defined by a ceiling and two walls). In some embodiments a radar system may be provided with a substantially downward boresight direction (e.g. disposed on or in a ceiling). There may be more than two radar systems (for example looking in many different directions, and/or in many different positions). At least some of the radar systems have a common field of view.

Arranging at least some of the radar systems with boresights at different angles results in better data about the objects within the common field of view of the radar systems, with less ambiguity, since range data in one system is correlated at least partly with azimuth/elevation direction information in another radar system. The combination enables more sensitive and specific subject detection, tracking and pose estimation within the detection region 40.

Both the first radar system 21 and the second radar system 31 communicate with a processor 10. Each radar 21, 31 system is configured to provide the processor 10 with data points corresponding with detected objects. The processor 10 is configured to combine the data points from the plurality of radar systems 21, 31 to detect and optionally track subjects (e.g. human subjects) within the detection region 40. The detection region 40 may comprise a region of overlap between the first and second radar systems 21, 31. A detection region may be defined as a region of overlap between any two complementary radar systems. Complementary radar systems may be defined as having boresight directions that differ by more than 25 degrees (for example by at least 45 degrees, or by 90 degrees) and different locations.

Each of the first radar system 21 and the second radar system 31 may comprise the same type of radar. Each radar system (used for the first and second radar system) may be a mmWave radar, with a frequency of 76 to 81 GHz. Each radar system comprises three transmitters and four receivers, operating concurrently, and integrated circuits and hardware accelerators for a complete data processing chain. Of course, other systems may be used with different numbers of transmitters and/or receivers. An example of a suitable radar system is the TI IWR1443¹. ¹ https://www.ti.com/product/TWR1443

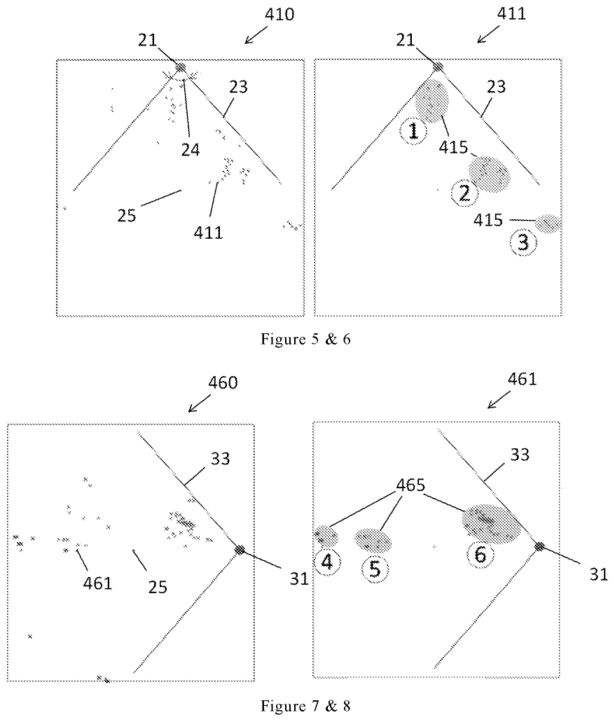

A block diagram of a signal processing chain of a suitable radar system is shown in FIG. 3. Each radar system may be configured to send electromagnetic signals in the form of a chirp signals Sₜₓ (i.e. a signal with frequency increasing linearly with time) to detect any objects in the receptive field of the radar (e.g. in front). When the chirp signal is reflected by an object, a reflected signal Sᵣₓ is returned to the radar and detected. The transmitted and received signals are depicted at 210.

The radar system combines the two signals Sₜₓ and Sᵣₓ with a mixer, the output of which is filtered to produce an intermediate frequency (IF) signal, as depicted at 220. The IF signal has a frequency equal to the difference in frequency between the transmitted and received signals and a phase that is equal to the difference in phase between the transmitted and reflected signals. Assuming that received signals are received while the chirp is still in progress, the frequency difference between the received and transmitted signals will be proportional to the time of flight of the received signal, which is in turn proportional to the range to the reflecting object.

A distance d can be estimated from:

$$d = \frac{( {f}_{1} - {f}_{2} ) c}{2 S}$$

where S is the slope of the chirp signal, f₁ is the frequency of the transmitted signal, f₂ is the frequency of the received signal and c is the speed of light.

A Fourier transform (e.g. FFT) of the IF signal will yield peaks with frequencies that correspond to the range of the objects producing the returns. In order to separate two close frequencies in a Fourier transform, we need to have f₁−f₂>1/T where T is the duration of the chirp signal (which defines the maximum length of the IF signal to be Fourier transformed).

The distance resolution dᵣ is therefore defined by:

$${d}_{r} > \frac{c}{2 S T}$$

where ST is the total bandwidth of the chirp signal. In practice, mmWave radar often use 3-4 GHz bandwidth, resulting in distance resolution of around 4 cm. This is useful for subject detection, tracking and pose estimation. It is both sufficiently imprecise to ensure privacy and sufficiently precise to provide reliable subject detection, tracking and pose estimation.

The signal processing chain following production of the IF signal is depicted at 230.

Beam forming techniques, based on phase differences at antennas at different spatial locations, may be used to determine the angle of different objects. In the context of radar systems, it is conventional to use an angular coordinate system comprising range, elevation angle and azimuth angle. In a conventional orientation of a radar system, azimuth is an angle in the horizontal plane, and elevation an angle in a vertical plane.

Assuming that there are a number of receivers, separated by a distance of l=λ/2, we can calculate the angle-of-arrival of a signal as:

$$θ = \frac{λ Δ ϕ}{2 π l}$$

where Δϕ is the phase difference between the receivers, and λ the wavelength of the signal. Signals from subsequent antennas will form a linear progression in terms of phase, and an estimation of θ can be made with another Fourier transform (to provide an angle-FFT). The angular resolution again depends on the number of samples we have for determining the angle-FFT, which is determined by the number of antennas. With Nₜₓ transmit antenna and Nᵣₓ receive antennas, a virtual array of Nₜₓ×Nᵣₓ can be generated with MIMO techniques, and the angular resolution written as:

$${θ}_{r} = \frac{λ}{l \cdot cos ( θ ) \cdot {N}_{t x} \cdot {N}_{rx}}$$

In some embodiments, at least some of the radar systems may determine a velocity of detected objects. In order to achieve this, two chirps may be transmitted, separated by T_{c}. Each reflected chirp may be processed by FFT (fast Fourier transform) to produce a range-FFT that encodes the range of each object. The phase difference between each peak in the range-FFTs from the first and second chirp encodes the velocity of the object. The velocity can be calculated from:

$$Δ ϕ = 2 π \frac{2 \cdot {T}_{c} \cdot v}{λ} ⇒ v = \frac{π Δ ϕ}{4 π {T}_{c}}$$

To get an accurate velocity estimation, the radar sends multiple successive chirps to form a chirp frame, and performs a Doppler-FFT over the phases received from the chirps in the chirp frame to find the velocity.

False returns are a problem for radar systems, so a constant false alarm rate (CFAR) algorithm may be implemented by the radar system to control and reduce the impact of noise on the returned data points.

The final step in the signal chain from each radar system is to periodically produce a data packet or frame comprising a plurality of data points. Each data point comprises a position (e.g. x, y, z or range, azimuth, elevation) of an object relative to the reference frame of the radar system, a strength of the radar return associated with that object and the velocity of that object.

In an example embodiment, the radar configuration may be tuned for indoor environments, with a maximum range of 8 m, a range resolution of 4 cm, a maximum velocity of 1 m/s, and a velocity resolution of 0.1 m/s. The time of each chirp may be 125 microseconds with a 10 microsecond idle time between chirps. The chirp ramp time may be 115 microseconds. The slope rate may be 35 MHz per microsecond, hence using the full 4 GHz bandwidth.

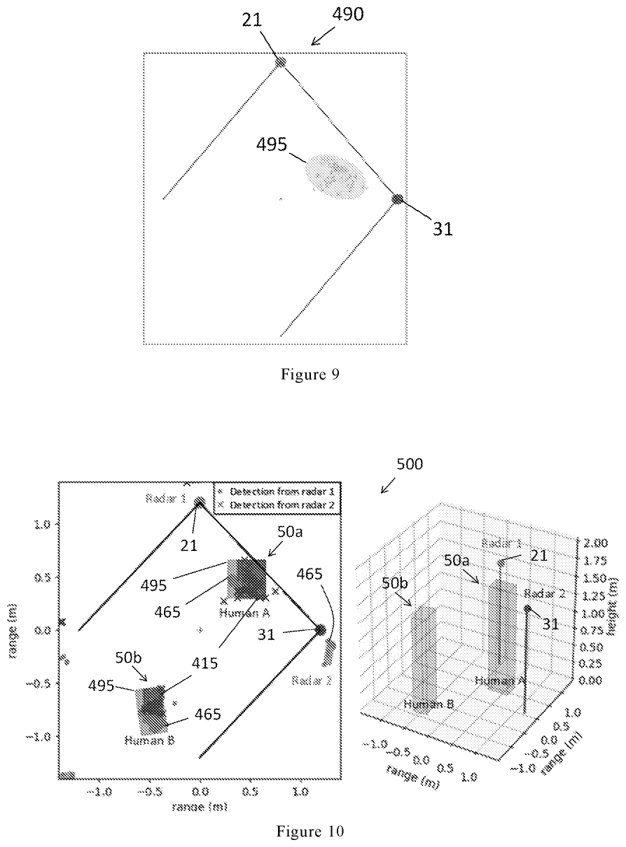

FIG. 4 shows a block diagram of a software framework 300 in an example embodiment. The processor 10 may comprise (but is not limited to) a PC or similar computer. The framework 300 utilises a multithreaded environment.

A number of threads are spawned at startup. Each radar system will have an independent radar handling thread 351, 352, 353 spawned. The example system comprises an arbitrary number of radar handling threads 351, 352, 353, including first and second radar handling threads 351, 352 and final ‘nth’ radar handling thread 343. The other reference numerals are similarly numbered, with numerals ending in ‘3’ referring to the final ‘nth’ integer. The software framework may, of course, be configured to handle two radar systems, three radar systems, or more radar systems (because the approach is readily scalable).

The radar handling threads 351, 352, 353 communicate with the radar systems and perform pre-processing on the data. In addition, a visualization thread 310 will be spawned with a visualizer GUI module 320 and a number of frame processors 341, 342, 343 to perform post-processing of the received data.

Each radar 371, 372, 373 comprises a serial port in communication with a corresponding serial port 361, 362, 363 of the processor 10, for communicating frames comprising data points to the radar handling threads 351, 352, 353. A second serial port of each radar system may also be connected to the processor for configuration of the radar system.

The radar handlers 351, 352, 353: i) configure each radar for obtaining data (e.g. by writing configuration data to an appropriate port of the respective radar 371, 372, 373); and ii) receive data (in the form of frames of data points) from each radar 371, 372, 373.

The radar handlers 351, 352, 353 may be configured to extract data from the data points of each frame to form an N by 3 matrix for that frame, where N is the number of detected objects and the x-y-z co-ordinates are stored in each row.

The frame processors 341, 342, 343 receive each radar frame and process it. Three types of frame processing may be performed by the frame processors 341, 342, 343: temporal stacking, clustering and foreground extraction.

Temporal stacking may comprise merging frame data in the temporal dimension, so that frames after stacking comprise data points obtained from more than one chirp (or chirp frame). In some embodiments, each frame comprises at least five or at least ten chirp frames. This ensures that each frame (after stacking) has an increased number of data points, which may be more suitable for subsequent clustering operations. Stacking of the frame data can help stabilise subject detection, as data points from real points will be emphasised but the noise will not. The frame processors 341, 342, 343 may store and stack the frames using a first-in-first-out (FIFO) queue. The frame processors 341, 342, 343 may also apply a coordinate transform to the data from each camera to map it to a common coordinate reference frame (e.g. based on a known position and orientation of each radar system), but this can also be done later in the processing chain.

A clustering module may be implemented by each frame processor 341, 342, 343 to group data points in each frame (after temporal stacking) according to their distance. Optionally, clusters with a low number of points (e.g. fewer than 5, or fewer than 2) may be discarded as likely to be noise. Any suitable algorithm for clustering can be used, such as DBSCAN (density-based spatial clustering of applications with noise). This algorithm helps in reducing noise. A threshold distance for clustering may be defined, for example 15 cm, where points that are within this distance of each other are classified into a cluster.

A foreground extraction module may be provided, which attempts to learn the environment during a setup period (e.g. some frames when there is no subject). Once the setup period is finished, the clustering module may be employed to detect clusters of data points and record these in a database as clutter. For subsequent frames, the foreground extraction module can compare new clusters with the clutter clusters in the database and filter out those with a similar size and location. This foreground extraction module can be useful when the system is to operate in an environment with irrelevant static objects (but is not essential).

The resulting clusters from each frame processor thread 341, 342, 343 may subsequently be passed to the central frame processing thread 330 for data fusion, candidate subject identification and tracking.

The central frame processing thread 330 may be triggered when results from the frame processor threads 341, 342, 343 are ready. If the data is not already transformed to a common coordinate system, the central frame processing thread 330 may transform the data to a common coordinate system. It may be more efficient to wait until clusters are identified for this mapping to a common reference frame, since transforming the data points may consume computing resources which will be wasted if the points are not retained in clusters.

The central frame processing thread 330 determines a centroid of each cluster and the volume comprising each cluster. Clusters are compared to see to what extent they overlap, and how close their centroids are. If the centroids are close (e.g. within 20 cm) and the majority of the volume is shared, the combined cluster is treated as a verified cluster. The verified cluster may be taken from the combined volume of the two clusters (corresponding with a Boolean OR). In some embodiments, a projection of the data onto a plane (e.g. a horizontal plane) may be used to determine the extent of overlap. Any clusters that are not verified by reference to a corresponding cluster from another radar may be discarded.

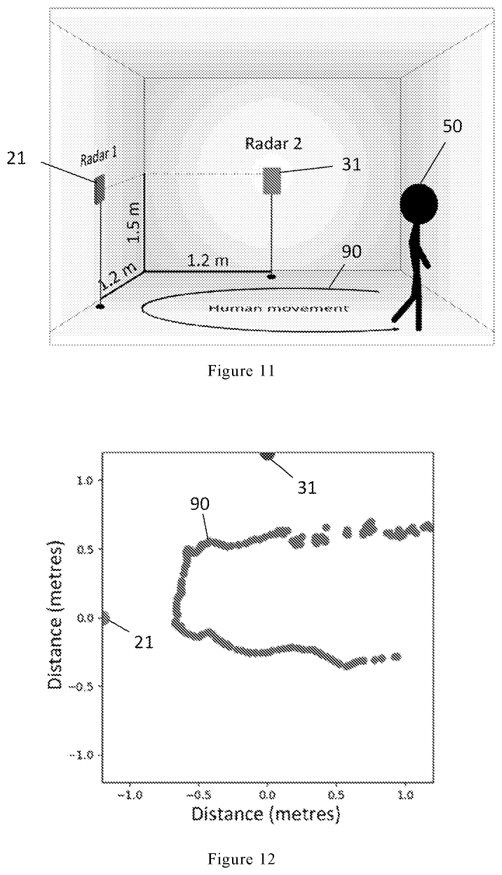

This process of fusing clusters from different radar systems is illustrated in FIGS. 5 to 9. In FIG. 5, data points 411 are shown from a first radar system 21, with the boresight in the horizontal plane and a viewing angle 24 of approximately 90 degrees. A point 25 on the boresight of the radar system 21 is shown. In FIG. 6, clusters 415 are determined from the data points (indicated by 1, 2, 3).

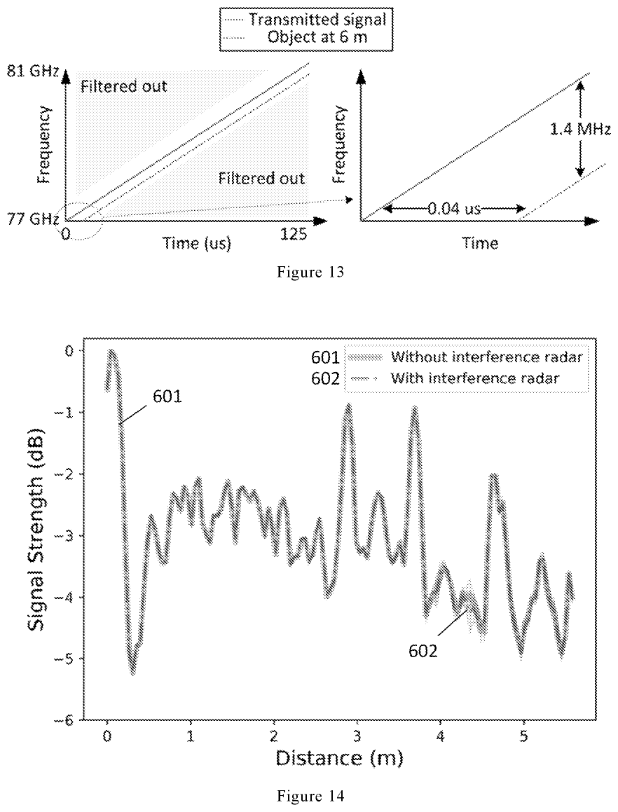

FIG. 7 shows data points 461 from a second radar system 31 with the boresight in the horizontal plane and at an angle of 90 degrees to the boresight of the first radar system 21. FIG. 8 shows clusters 465 determined from these data points (indicated by 4, 5, 6). Point 25 on the boresight is shown (which is in the same position as point 25 in FIGS. 5 and 6).

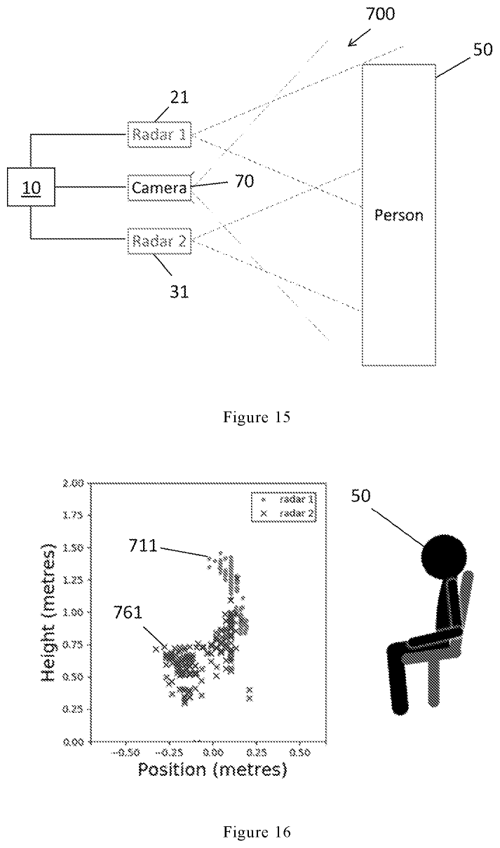

FIG. 9 shows the verified cluster 495, resulting from the agreement between clusters 2 and 6. The other clusters may be discarded as non-relevant, or not analysed further. A candidate human model can be constructed from one or more verified clusters and the underlying point cloud data. The candidate human model may comprise estimates for a person's position, height and volume. These properties are not necessarily an accurate representation of the subject, but provide useful information for comparing and distinguishing candidate subjects.

The candidate human models (comprising at least one cluster e.g. a group of clusters) may be passed to a tracking module, which may correlate the candidate with previous frames. A temporal window comprising a plurality of frames (e.g. 25) may be used for comparing candidates, looking for the best match from the other candidates in terms of proximity and optionally also size. If a candidate from another frame within the temporal window is found with sufficiently similar size and location, they are considered to be the same object and the candidate positions in different frames may be considered a track (since they comprise a set of locations of the candidate over time). Decision thresholds for similarity in size and position may be determined by training with a range of subjects moving at a range of speeds.

The tracking module may keep records of the live time of each detected candidate and may only report the presence of a subject if the candidate track has persisted for more than a predetermined time (such as one second, or half a second). This may help avoid the identification of phantom subjects resulting from noise. The track may be smoothed with a moving average (e.g. with a window corresponding to 1 second, or half a second) to give a more accurate estimate of location, on the assumption that the subject is unlikely to move fast, so that the position is unlikely to vary much within the averaging window.

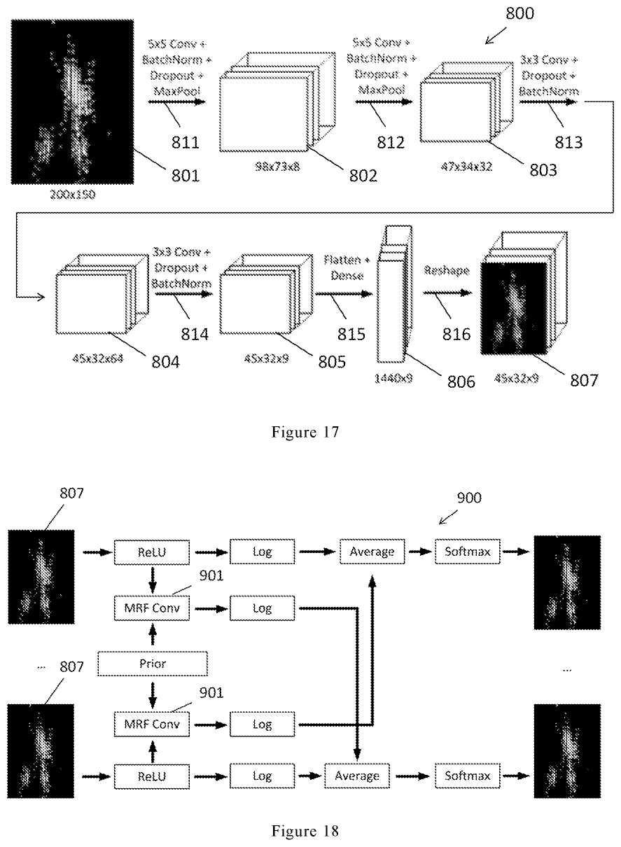

FIG. 10 illustrates that a system according to an embodiment can identify multiple people at the same time, showing a first subject 50a and a second subject 50b, both identified as verified clusters from intersecting clusters 415, 465 from the first radar system 21 and second radar system 31.

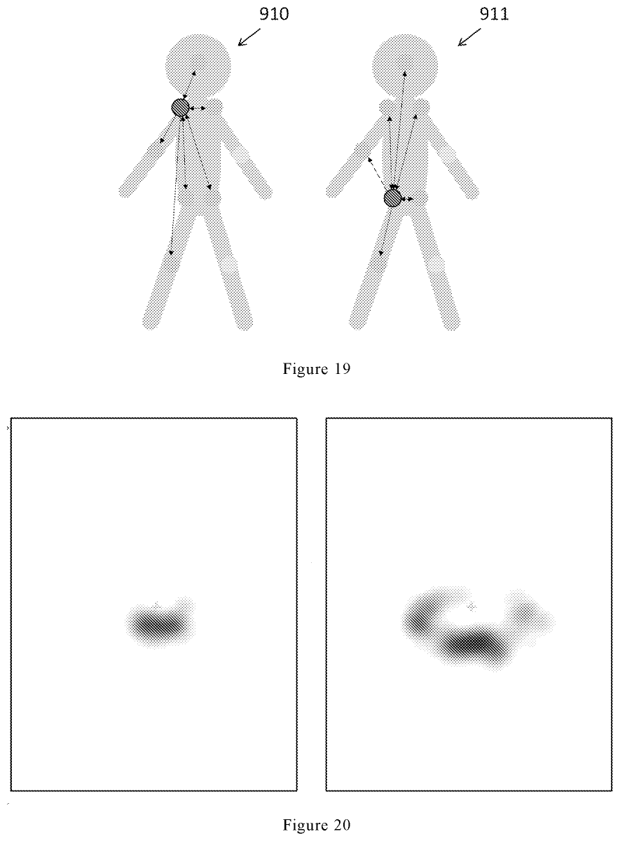

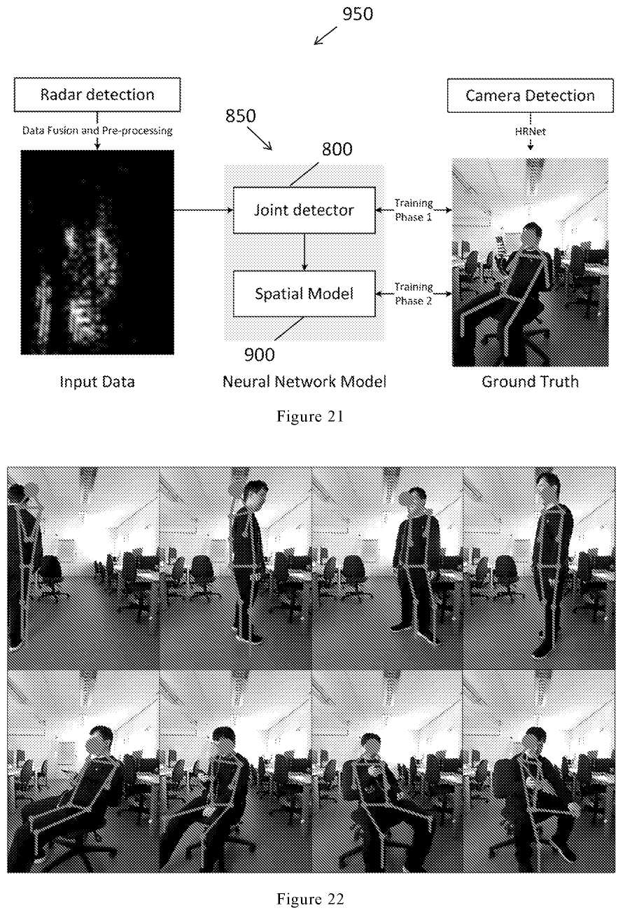

FIGS. 11 and 12 show tracking of a human subject, with a schematic illustration shown in FIG. 11 of a human movement track 90 in a room space viewed by a first and second radar system 21, 31. FIG. 12 shows a track 90 comprising a sequence of centroid locations of a candidate human model obtained from the first and second radar systems 21, 31.

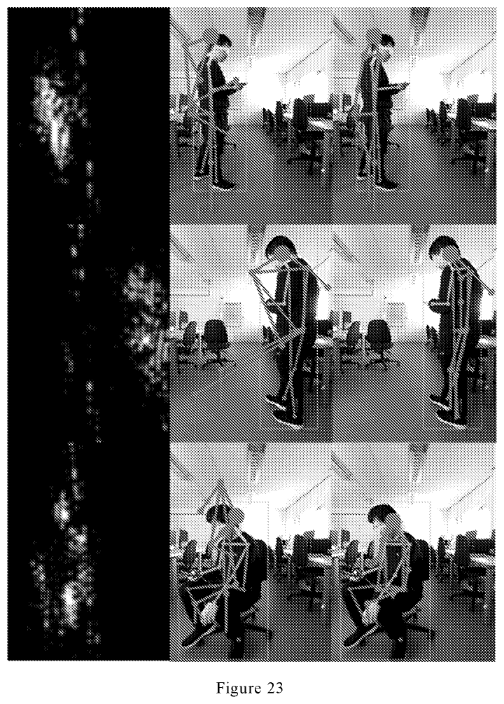

When using multiple radar systems, it is important to ensure that they do not interfere with each other. Assuming that there is a maximum measuring distance of 6 m, the time of flight of the round trip is up to 0.04 microseconds. With a 35 MHz/microsecond slope rate, the round trip period gives a frequency change of around 1.4 MHz, as shown in FIG. 13. Assuming that there are two radars working simultaneously, the transmitter signal and the receiver signal for the two radars (denoted with subscript 1 and subscript 2 respectively) can be represented as:

Sₜₓ₁(t)=sin(2πf₁t)

Sᵣₓ₁(t)=sin(2π(f₁−1.4 MHz)t)

Sₜₓ₂(t)=sin(2πf₂t)

Sᵣₓ₂(t)=sin(2π(f₂−1.4 MHz)t)

Assuming the signals Sₜₓ₂(t) and Sᵣₓ₂(t) are also detected by the first radar, the mixer will produce a combination of sinusoidal signals with six different frequency components:

$${S}_{m i x} ( t ) = sin ( 2 π \cdot 1.4 MHz \cdot t ) + sin ( 2 π \vert 2 \cdot {f}_{1} - 1.4 MHz \vert t ) + sin ( 2 π \vert {f}_{1} + {f}_{2} \vert t ) + sin ( 2 π \vert {f}_{1} - {f}_{2} \vert t ) + sin ( 2 π \vert {f}_{1} + {f}_{2} - 1.4 MHz \vert t ) + sin ( 2 π \vert {f}_{1} - {f}_{2} - 1.4 MHz \vert t )$$

Since both f₁ and f₂ are within 77 to 81 GHz, many of these terms will have frequencies that are very high and will therefore be filtered out by a low-pass filter following the IF mixer. This leaves three terms:

S_{filtered}(t)=sin(2π·1.4 MHz·t)+sin(2π|f₁−f₂|t)+sin(2π|f₁−f₂−1.4 MHz|t)

The first term is the term that contains the desired signal, and the second two terms are interference signals. By configuring an analog to digital converter (ADC) sampling rate (sampling the filtered IF signal) to avoid sampling high frequencies, and with the help of a digital filter, frequencies beyond 1.4 MHz can be filtered out. This will have the result of limiting the detection range to a 6 m range (for the illustrative example), corresponding to a 0.04 microsecond period. Assuming a cut-off frequency of 1.4 MHz for a filter implemented after the IF mixer, the two interference terms in S_{filtered} will only be retained if |f₁−f₂|<1.4 MHz or |f₁−f₂+1.4 MHz|<1.4 MHz. This sets a condition for interference to be present:

−2.8 MHz<(f₁−f₂)<1.4 MHz

This means that the two radars will only interfere if their frequency difference falls into the 4.2 MHz range defined by the inequality above. With a 4 GHz bandwidth and radars switched on (i.e. chirp start) at a random time, there is therefore a probability of around 0.1% of interference between the radar.

As a proof-of-principle, two radar were placed at a close distance and pointed toward the same scene from different angles. One radar (referred to as the main radar) was kept switched on, and the other radar (referred to as the interfering radar) switched on and off at random times. The scene was set up with static objects placed between 0.5 m and 5 m and kept unchanged at all times.

The experiment was carried out at multiple times with different radar locations and recording durations. The average variances of the main radar's detection results were recorded and these are shown in Table 1, below. In all cases the variances are very similar for the entire scene within the 6 m range, regardless of the status of the interference radar. Paying particular attention to detection within 3 m, or detection with signal strength greater than −3 dB (which are both in the range of practical detection of subjects), the variances are even lower.

TABLE 1

| | Average variance of the | |
|---|---|---|
| | main radar's detection | |
| | of static objects (m) | |
| | Interference | Interference |
| | radar | radar |
| | active | inactive |
| All detection | 0.23 | 0.20 |
| Detection within 3 m | 0.08 | 0.07 |
| Detection with signal | 0.06 | 0.07 |
| strength >-3dB | | |

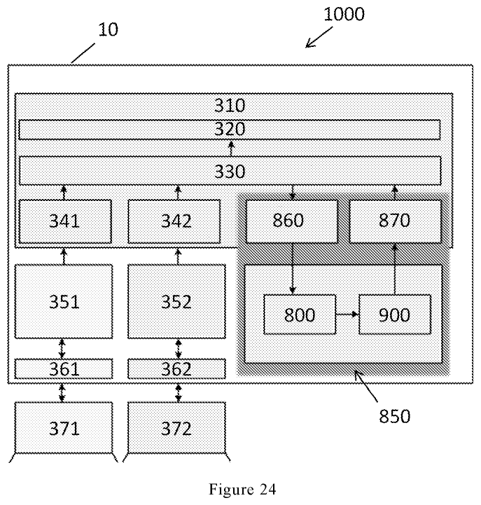

FIG. 14 shows a comparison between the results obtained from the main radar with the interfering radar switched on and off (601, 602), showing there is very little difference between the signals with and without interference.

The chance of interference can increase if the system includes more than two radars. When there are N radar systems picking random 4.2 MHz frequency bands on the 4 GHz band, the probability of interference is the probability that any two of the radars pick the same frequency, which is:

$$P ( N ) = 1 - {\prod }_{i = 1}^{N} \frac{4 GHz - 4.2 MHz \cdot ( i - 1 )}{4 GHz}$$

The probability of interference is generally very low (less than 1%) with four radar systems and less than 5% with ten radars. This figure will be higher with more than ten radars. Systems with a large number of radars may require synchronisation between radar systems and/or an interference detection algorithm. In the event that interference is detected, the radar can be re-initialised with different respective start times, until the interference is reduced to an acceptable level.

In order to test the performance of a radar system according to an embodiment, tests have been carried out against tracking information obtained by a camera system. Camera based human tracking systems have been studied in depth and provide a reliable baseline for evaluation.

A well-known approach for the camera system was used (as described in Redmon, Joseph, and Ali Farhadi. “Yolov3: An incremental improvement.” arXiv preprint arXiv:1804.02767 (2018)). Each candidate detected by radar was compared with camera detected volumes corresponding with a subject. The centroid of the radar detected candidate was considered accurate if it was within 0.25 m of the centroid of the camera detected volume and having at least 70% overlapping volume. Systems according to an embodiment (comprising multiple radar, which determine verified clusters based on agreement between radar) were compared with single radar systems.

Experiments were performed in a 2.4 m×2.4 m room, and the system was run for 2 days. Data was collected when there was at least one human present in the area. During 56.8% of the time, there was only one person present, 12.1% with two people and 19.6% with three people, and the rest with more than three people.

The results are shown below in Table 2:

TABLE 2

| | Sensitivity | Precision |
|---|---|---|
| One radar | 96.4% | 46.9% |
| Two radars | 90.4% | 98.6% |

The high sensitivity for both single radar and two radar systems indicates that, whenever a human is present in the area, the system has a very high probability of detecting it. However, with one radar, the 46.9% precision indicates that more than half of the detections would be false detections. With two radars (in accordance with an embodiment), the system sensitivity was reduced slightly, but the precision improved significantly to 98.6%. In other words, when the one-radar setup detects an object, there is a greater than 50% chance it is a false detection, whereas with two radars, detection is with a high level of confidence (>98%).

When detecting with one radar, the system reports a large number of false alarms due to noise and flicking of the results. The flicking is observed because of the FFT processing and the peak detection algorithm, where a small change in the signal, once it comes through the FFT, can result in a change in the FFT bins and hence a few centimetres displacement on the object coordinates. This effect is enlarged when carried over to the angle-FFT, where a displacement in the angle will result in a much larger displacement in the 3-D space. When using two radars, in accordance with embodiments, the system has access to two independent detections which can verify the results from each other. As a result, the false alarm rate was reduced significantly (represented by the rise in precision) with only a tiny reduction in the sensitivity.

When there are three or more people and people are occluded by others, more radars may be used to cover the scene from more angles. It is straightforward to modify the examples described herein to work with more than two radar systems.

Posture Estimation Using Machine Learning

Camera based methods for human posture estimation have become a popular topic in computer vision. Being able to obtain an accurate estimation of a person's posture enables computers to understand human behaviours and provide appropriate assistance or interaction, which can be beneficial in many applications, such as health care, security and gaming. While camera-based methods have shown an impressive accuracy on optical images, their intrusive nature makes them unsuitable for many applications (e.g. due to privacy concerns etc). Posture analysis using radio-frequency signals and radars has been an emerging area, and may have applications in health monitoring (e.g. geriatric care homes and secure units) and penal contexts (e.g. for suicide prevention, etc).

mmWave radars have the advantages of being non-intrusive, having a high bandwidth and resolution, and small antenna size. These features allow detailed information of the subject to be collected and analysed, using a low-cost platform and an easy setup.

In an embodiment, a convolutional neural network (CNN) model is used to estimate human posture. The model consists of two parts: a part detector model for an initial estimation on the positions of the key joints of the person, and a spatial model to learn the position relationship between these joints and refine the estimation from the part detector. The positions of certain key joints can be used to form a concrete representation of the entire body posture. Temporal correlation of the joints between time frames may be used to improve the smoothness of the estimation.

In an example embodiment, each mmWave radar has three transmitters, four receivers and a programmable data processing chain on the chip (other arrangements are of course possible).

The radar is able to detect objects in the scene and report them to a computer in the form of point clouds, in real-time (for example, at 10 fps or faster). By applying the data processing chain described above (with reference to FIG. 4), irrelevant information may be filtered out (such as clutter and noise) and people in the scene located. The posture of the person will be encoded in the shape of the point cloud.

A model may be applied to data derived from the point cloud to estimate postures based on the point cloud. Using a graphic processing unit (GPU) or an application specific processor (which may be configured to efficiently implement machine learning models), posture analysis can performed in real-to provide an accurate estimation of a person's posture.

There have been very few studies on posture estimation using mmWave radar^{2, 3, 4}, and there is considerable room for improvement, particularly in the determination of arbitrary human posture (not limited to standing and walking postures). The approach described herein is applicable to accurately determine a wider range of human postures. ²A. Sengupta, F. Jin, R. Zhang, and S. Cao, “mm-pose: Real-time human skeletal posture estimation using mmwave radars and cnns,” IEEE Sensors Journal, 2020³ G. Li, Z. Zhang, H. Yang, J. Pan, D. Chen, and J. Zhang, “Capturing human pose using mmwave radar,” in 2020 IEEE International Conference on Pervasive Computing and Communications Workshops (PerCom Workshops), 2020, pp. 1-6.⁴A. Sengupta, F. Jin, and S. Cao, “Nlp based skeletal pose estimation using mmwave radar point-cloud: A simulation approach,” in 2020 IEEE Radar Conference (RadarConf20), 2020, pp. 1-6.

mmWave radar are able to transmit high frequency radio signals, process the reflected signal from the scene and report any detected objects as point clouds. In order to transform a point cloud into a fixed-size data format, as required by a typical CNN model, the point cloud may first be projected to a fixed-size 2D image. The intensity of each pixel may encode the strength of the radar return for that point. In some embodiments the intensity of each pixel may encode the z-position with respect to an image plane (on which the point cloud has been projected). In some embodiments, the intensity may comprise a weighted sum of the z-position and the return strength. In some embodiments the fixed size data format may comprise more than one intensity value (similar to R,G,B pixels, in which each spatial position comprises three intensities). The intensity values may comprise z-position and return strength.

In the case where there is more than one radar system, a particular image plane may be selected, which may be normal to the boresight of one of the radar systems. In other embodiments a particular image plane may be selected that is not normal to the boresight of one of the radar systems.

In order to train a machine learning algorithm, ground truth data is required for the input data. Ground truth data may be generated using a standard camera and a prior art posture estimating algorithm (HRNet⁵). Alternatively, an IR camera may be used (e.g. a Kinect camera or similar), and any suitable (i.e. accurate) algorithm may be used to estimate joint positions of a the person. ⁵K. Sun, B. Xiao, D. Liu, and J. Wang, “Deep high-resolution representation learning for human pose estimation,” in CVPR, 2019

The joint positions (to be estimated as a proxy for posture) may comprise: heard, left and right shoulders, hips, elbows and knees. In some embodiments the joint positions for wrists and ankles may be omitted, since the mmWave signal from these joint locations is typically weaker and hence relatively uncertain, and these joint positions are relatively unimportant in estimating the overall body posture.

The joint positions (or estimates thereof) determined from visual and/or IR images may be used as ground truth to train a machine learning algorithm for processing point clouds obtained from one or more mmWave radar systems to determine posture. In order to enable simple and smooth determination of a loss function (used in training), a heatmap for each joint may be determined by placing a gaussian kernel on each joint position determined by the ground truth algorithm. The heatmap may define an error-tolerance of the mmWave machine learning model during the training stage.

FIG. 15 shows a radar system 700 according to an embodiment, comprising a first radar system 21, a second radar system 31, a camera 70 and a processor 10. Each of the first and second radar systems 21, 31 may be similar to those already described with reference to FIG. 1, and the processing of signals from the radar systems 21, 31 to obtain point clouds may similar to that already discussed above. The radar systems 21, 31 may each be configured to provide radar frame data to the processor 10. The processor 10 is configured to determine human posture from the frame data received from the radar systems 21, 31, and may be trained to do so based on truth data obtained by processing information obtained from the camera 70.

In pre-trained embodiments (where a machine learning algorithm implemented by the processor 10 has already been developed), the camera 70 may be omitted. In some embodiments, a single radar system may be used to provide the information from which posture is determined by the processor 10. The training process and a suitable machine learning architecture will be described in more detail below.

FIG. 16 shows a point cloud obtained from a two radar system like that shown in FIG. 15. In this example, the first radar system 21 was at a height of 1.2 m from the floor, and the second radar system 31 at a height of 0.7 m from the floor. In embodiments where the radar systems are vertically arrayed, the first radar system may be spaced apart from the second radar system by a distance of between 0.3 and 0.7 m. The camera was placed at 1 m from the floor. The point cloud comprises data points 711 from the first radar system 21 and data points 761 from the second radar system.

A set of training data and a set of test data may be obtained by concurrently capturing data from both the camera 70 and one or more radar systems 21, 31. A machine learning algorithm may be trained on the training data and the machine learning algorithm subsequently tested using the test data. The training data may be augmented by applying rotations and translations and shuffling of the subsequent datasets. This may help avoid overfitting and increase the robustness of the machine learning algorithm.

In the example embodiment, the input resolution was 200×150 pixels, and the output resolution (i.e. the grid for placing each joint) was set at 45×32 pixels. Other resolutions may be used, depending on the sensor resolution and available computing power and efficiency. The training dataset used in the example has 24,000 training data instances, and 2,600 test data instances.

An example part detector algorithm architecture 800 is shown in FIG. 17. The algorithm receives input data 801 from one or more radar systems. The input data may be obtained by fusing point clouds from more than one radar system, as disclosed herein.

The input data may have dimensions of 200×150. A first convolutional superlayer 811 comprises a convolution layer with a 5×5 convolution kernel, followed by a batch normalisation layer, a dropout layer and a max pooling layer. The output 802 of the first convolution superlayer 811 has dimensions of 98×73×8. A second convolutional superlayer 812 again comprises a convolution layer with a 5×5 convolution kernel, followed by a batch normalisation layer, a dropout layer and a max pooling layer. The output 803 of the second convolutional superlayer 812 has dimensions of 47×34×32. A third convolutional superlayer 813 comprises a convolution layer with a 3×3 convolution kernel, a dropout layer and a batch normalisation layer. The output 804 of the third convolutional superlayer 813 has dimensions of 45×32×64. A fourth convolutional superlayer 814 comprises a convolution layer with a 3×3 convolution kernel, a dropout layer and a batch normalisation layer. The output 805 of the fourth convolutional superlayer 814 has dimensions of 45×32×9. A penultimate layer 815 flattens the output 805 from the fourth convolutional superlayer and comprises a dense (fully connected) layer. The output from the penultimate layer 815 has dimensions of 1440×9. This is re-shaped in the final layer 816 to produce heat maps that provide position estimates for each of the 9 joints. The output from the final layer is 9×45×32 intensity map, one for each of the Joint positions. All of the convolution superlayers also comprise a rectified linear unit activation function, and the penultimate layer uses the softmax function to generate the heatmap.

Although reference to specific operations and data dimensions at each stage has been made, these are merely exemplary, and other operations and data dimensions may be used in an alternative implementation (e.g. more or fewer convolutional layers, differently dimensioned input data, higher or lower resolution output joint position estimations etc).

One advantage of the radar data is that, since the data is 3D, the distance between the subject and the radar will not affect the size of the subject in the input data. This is in contrast to image based data, in which the subject will appear smaller when they are further away from the camera. The projection of point data from the at least one radar onto a 2D plane may be inherently scale-invariant, which eliminates the necessity of using different-sized convolutional layers and extracting features at different scales.

The part detector is able to provide a first estimation of the joint positions. However, the determination of the position for each joint is independent and the part detector does not take into account the relative positions between the joints. This can lead to anatomically incorrect postures. In order to address this issue, an additional spatial model is included in the overall algorithm for determining posture from radar data points. The spatial model encodes prior knowledge about the expected relationship between the positions of the different joints.

The spatial model may be based on a dependency graph, and may refine the joint positions using a Markov Random Field model. Equation 1 below may be used to refine the joint positions:

$${\hat{P}}_{i} = exp ( \frac{1}{\vert {V}_{i} \vert} {\sum }_{v ∈ {V}_{i}} log ( {P}_{i \vert v} * {P}_{v} + {b}_{v - > i} ) ) \qquad ( 1 )$$

where Pᵢ is the heatmap output from the part detector for joint i, \hat{P}ᵢ is a refined heatmap output after the spatial model; v∈Vᵢ are the joints that are considered to be related to joint i, including itself, P_{i|v} and b_{v->i} are the weights and bias terms that model the spatial relationship between joints i and v;

$$\frac{1}{\vert {V}_{i} \vert}$$

is the normalisation term used to scale the variable with respect to the number of joints involved.

FIG. 18 shows an architecture for a spatial model 900 according to an embodiment. The MRF function is implemented as a convolution operation 901, where P_{i|v} is defined as the convolution kernel and b_{v->i} is the bias term. The convolution operation models how the estimation of joint v contributes to the estimation of joint i. Five joints were defined as primary joints that are all dependent on each other. The primary joints comprise: the head, the left and right shoulders, and the left and right hips. The other four joints were defined as secondary joints that are dependent on the primary joints. The secondary joints comprise the left and right elbows and knees. The convolution kernels P_{i|v} are set to twice the size of the heatmap (in the example case, 90×64 pixels, but other sized heatmaps may be used). Since the kernels encode the prior knowledge of the joints' spatial relationships, the weights of the kernels may be initialised by collecting the pair-wise position dependency between the joints from the ground truth in the training dataset.

The ReLU (rectified linear unit) function may be applied to the heatmaps and the convolution kernels (P_{i|v} and b_{v->i}) to ensure non-negative values and improve the stability of the network.

The spatial model is appended at the end of the part detector model. The spatial model takes the heatmap output from the part detector and generates a refined heatmap, as shown in FIG. 18. The final heatmap is the probability distribution of the joints' positions. The location of the peak values in the heatmap may be taken as the x-y coordinates of the joint, as shown in equation (2):

xᵢ,yᵢ=argmax_{x,y}(\hat{P}ᵢ) (2)

FIG. 19 shows an example of a dependency graph for the left shoulder 910, and for the left hip 911. The double arrows indicate that the two joints are inter-dependent, and the single arrows indicate a one way dependency.

FIG. 20 gives an example of prior knowledge (encoded in the convolution kernels P_{i|v}). The left image shows the likely position of the left and right shoulders respectively, given a position of the head as at the centre. The right image shows the likely position of the knees, given the position of the hips at the centre.

FIG. 21 illustrates an example training method 950. The two parts of the model may be trained separately using a two-phase training process. For example, the Adam optimiser may be used, with a dynamic learning rate of between 10⁻² and 10⁻⁵. Cross-entropy may be used to compute the difference between the estimated heatmap and the ground truth (in order to determine the loss function). The model may be implemented in any suitable environment, for example using the Keras library, implemented using Tensorflow, and trained using a commercially available GPU.

In a first training phase, the joint detector portion of the model may be trained to estimate the locations of the joints against the ground truth data. In a second training phase, the spatial model weights may be trained, based on the ground truth data, as described above. Optionally, errors may be back propagated through the combined model to further refine the kernel weights in both the joint detector and the spatial model.

The neural network model estimates the posture of the person independently in each time frame. However, as the radar is prone to noise and the point clouds can sometimes be unstable, the estimation can be further refined by exploiting temporal correlation between time frames, following the assumption that the joints are not expected to move much between successive time frames.

The output from the network at each timestamp will be recorded and analysed. Two parameters may be used to evaluate the quality of each estimation: the confidence of the neural network's estimation (C in Equation (3)) and the speed of the joints' motion (M in Equation (4)). The confidence may be inherited in the heatmap, represented by the peak value and the distribution of the heatmap from the Softmax layer. A sharp and dense distribution indicates that the network is confident on the joint position, whereas a sparse and flat distribution indicates a low confidence.

$$C = \frac{{\sum }_{i ∈ V} max ( {\hat{P}}_{i} )}{\vert V \vert}$$

The second parameter, M, the speed of the joints' motion, or the rate of change of the joint positions, is calculated from the Euclidean distance between the current position and previous position of each respective joint.

$$M = \frac{{\sum }_{i ∈ V} \sqrt{{( {x}_{[ t - 1 ]} - {x}_{[ t ]} )}^{2} + {( {y}_{[ t - 1 ]} - {y}_{[ t ]} )}^{2}}}{\vert V \vert} \qquad ( 4 )$$

The two parameters, C and M, are recorded as the system operates. In order to make the result of the joint position estimates more stable and avoid outliers, a real time stability test may be used. The estimation will be qualified if both the confidence C is high (e.g. greater than a predetermined threshold) and the motion speed M is within a predetermined threshold. If the confidence has dropped significantly, or if the new estimated position differs from the last one, the updated joint position estimation will be rejected. Instead, at least part of the joint position may be recorded, and the estimation from the previous frame may be used as the current joint position estimate. If the network produces a similar estimation of joint position (e.g. matching within a threshold Euclidean distance) over a predetermined period (e.g. at least 0.2 seconds, e.g. 0.5 seconds), the low confidence updated joint position estimation may be accepted.

In addition to the stability test, it may be assumed that the joint positions will move less than a predetermined distance between frames, and a restriction may be imposed on the maximum distance that each estimated joint position can move between successive frames. Given the x-y coordinates \hat{x}_{[t-1]},ŷ_{[t-1]} of a joint in at the previous time frame t−1, for the next frame t, a circular mask may be defined around \hat{x}_{[t-1]},ŷ_{[t-1]} with radius r, and the collection of all points within the mask may be defined as R, as shown in Equation 5.

R={x,y|(x−\hat{x}_{[t-1]})²+(y−ŷ_{[t-1]})²<r²} (5)

Given the output of from the neural network (x_{[t]},y_{[t]}), a search may be performed within the collection R for the nearest point to this output, for example, as defined by Equation 6.

\hat{x}_{[t]},ŷ_{[t]}=argmin_{x,y∈R}((x−x_{[t]})+(y−ŷ_{[t]})²) (6)

The temporal correlation step is optional but may be advantageous. For example, it can improve the accuracy of the system, and can significantly improve the visual smoothness of the posture estimation, since it may filter out abnormal postures and improve the smoothness of any motion.

An example system (as described with reference to FIGS. 17 and 18) was tested using the evaluation dataset, which was collected under the same conditions as the training dataset (comprising a person sitting and standing in the area for around 30 minutes). The accuracy of the example embodiment was tested against the ground truth generated by a camera system. A percentage of correct keypoints (PCK) metric, defined in Equation 7, was used to evaluate the accuracy of the system. The estimation of a joint may be considered correct if its position is within a certain distance from the ground truth position (in this case selected to be 4 pixels).

$$P C K = {\sum }_{i} ( {d}_{i} < 4 ) / \vert V \vert \qquad ( 7 )$$

where dᵢ is the Euclidean distance between the joint's estimated position and the ground truth, and V is the collection of all the joints. The PCK metric for all the three stages are shown in Table 1 below.

TABLE 1
PCK metrics

| | Part | Spatial | Temporal |
|---|---|---|---|
| | detector | model | correlation |
| PCK | 0.717 | 0.759 | 0.786 |

### Table 1 Shows the PCK Metric after Each of the Three Stages of the Model

An alternative measure of accuracy in joint position estimation is the object keypoint similarity (OKS) metric (defined in equation 8), as well as the mean localisation error for the joints. The calculation of the OKS considers the relative sizes of different joints with respect to the human scale.

$$O K S = {\sum }_{i} ( {e}^{- \frac{{d}_{i}^{2}}{2 {s}^{2} {k}_{i}^{2}}} ) / \vert V \vert \qquad ( 8 )$$

where s is the size of the object, and k is a pre-calculated constant that controls the weight of each joint based on a size of the joint. An average precision may then be calculated by counting the number of correct estimations from all frames, where an estimation is considered correct if its OKS value is higher than a certain threshold.

TABLE 2
OKS metrics and the mean localisation error

| | | | Localisation |
|---|---|---|---|
| | AP | AP | error |
| | (OKS = 0.5) | (OKS = 0.5:0.95:0.05) | (cm) |
| Example | 0.959 | 0.713 | 3.85 |
| embodiment | | | |
| HRNet⁵ | 0.928 | 0.782 | NA |
| UDP-Pose⁶ | 0.949 | 0.808 | NA |
| mm-Pose² | NA | NA | 2.7-7.5 |
| RF-Pose3D⁷ | NA | NA | 4.0-4.9 |

Table 2 shows OKS and mean localisation error for an example embodiment, and some reported error values from the prior art for joint localisation (i.e. posture estimation). The first result column reports OKS=0.5. This is a loose metric that accepts an estimation if the OKS is greater than 0.5. The second result column presents OKS=0.5:0.95:0.05, which is a more strict measure that calculates the average precision over 10 OKS thresholds from 0.5 to 0.95. ⁶J. Huang, Z. Zhu, F. Guo, and G. Huang, “The devil is in the details: Delving into unbiased data processing for human pose estimation,” in The IEEE/CVF Conference on Computer Vision and Pattern Recognition (CVPR), June 2020⁷M. Zhao, T. Li, M. Abu Alsheikh, Y. Tian, H. Zhao, A. Torralba, and D. Katabi, “Through-wall human pose estimation using radio signals,” in Proceedings of the IEEE Conference on Computer Vision and Pattern Recognition, 2018, pp. 7356-7365.

FIG. 22 shows some example results of posture estimation using an example system (after the temporal correlation stage).

FIG. 23 compares the output after the part detector (in red) and after the spatial mode (in blue), with ground truth positions also shown (in orange). When the point cloud data is noisy or ambiguous, the prior knowledge encoded in the spatial model can significantly improve the robustness of the model and avoid anatomically incorrect postures.

A system according to an embodiment may be implemented as described herein, using a radar handling module per radar system and a frame processor modules per radar system, and a single central frame processor to fuse the data and process the part detector, spatial model and temporal correlation. In the case of the example system with two radar systems, there may be two radar handling modules, two frame processor modules and one central frame processor.

It is difficult to directly compare results between different machine learning techniques, but it is clear that example embodiments are capable of joint localisation with similar performance to state of the art camera based techniques.

FIG. 24 shows an example system 1000 for posture detection. The system includes a number of features in common with that of FIG. 4, which are given like numerals. The description in relation to FIG. 4 is equally applicable to those features in FIG. 24. The system 1000 further comprises a posture detection subsystem 850, comprising a data preparation module 860, joint/part detector 800, spatial model 900, and a post processing module 870.

In the frame processor modules 341, 342, a FIFO module is used to stack data in the temporal dimension, and a DBSCAN clustering module is used to filter out noise. The central frame processor 330 synchronises the output from individual frame processors 341, 342 and fuses the data into one frame. The posture detection subsystem is invoked by the visualiser thread 319 and may be initialised on a GPU when the system starts, including allocating memory for the neural network, constructing the computational graph and loading the pre-trained weights into the model. The central frame processor 330 provides the fused frame data to the data preparation module 860, which converts the point clouds into 2D images by projecting the positions of the points onto an imaging plane. The resulting 2D images are provided to the joint/part detector 800, which determines an initial heatmap for each joint position, estimating the likely position of each joint. The heatmaps are provided to the spatial model 900, which refines the estimation of the position of the joints. The spatial model 900 provides joint position estimates to the post processing module 870, which may implement temporal correlation smooth the estimation of the positions (e.g. acting as a sort of low-pass on the rate of change of position). The positions from the post processor module 870 may be provided to the GUI 320 via the central frame processor 330.

In an example implementation, the entire process may take around 0.06 seconds to process one frame, resulting in an operating refresh rate of 15 frames per second (with update rates>10 frames per second being considered real-time in the context of this description).

The example results herein were obtained using a high power GPU, but such a system may also be implemented on an embedded system. As neural networks on mobile and embedded platforms become more common, many manufacturers are making dedicated systems for efficiently running well optimised machine learning. For example, TI provides the AM57x system-on-chip with the C66x digital signal processor and the Embedded Vision Engine (EVE) subsystems that are dedicated to accelerating neural network operations, with a low power-consumption of around 5 Watts. Although only 8-bit integers are supported, rather than floating-point numbers like a GPU, it is possible to compress a network through quantization, at the expense of reduced precision.

According to the TI deep learning framework, the EVE unit is able to perform 16 8-bit multiply-accumulate (MAC) operations per clock cycle, and it is typically clocked at 650 MHz. The example neural network shown in FIGS. 17 and 18 has around 107 million MAC operations in the part detector and 282 million MAC operations in the spatial model, which gives a theoretical maximum performance of 30 fps using a single EVE unit. The EVE unit can execute a few state-of-the art networks in real-time, such as the InceptionNetV1 network with 1500 million MAC operations in 785 ms. Given that the example network disclosed herein is much smaller, executing the network on a low power-consumption platform is clearly feasible in the short to medium term (e.g. an embedded processor with an application specific processor module or neural processing unit).

Embodiments of the system provides low cost and non-intrusive monitoring of posture solution and may have a large number of real-world applications.

Although the appended claims are directed to particular combinations of features, it should be understood that the scope of the disclosure of the present invention also includes any novel feature or any novel combination of features disclosed herein either explicitly or implicitly or any generalisation thereof, whether or not it relates to the same invention as presently claimed in any claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub combination.

The examples provided in the detailed description are intended to provide examples of the invention, not to limit its scope, which should be determined with reference to the accompanying claims.

1. A system for subject detection, comprising:
a plurality of radar systems, each comprising an antenna configured to transmit an electromagnetic signal and to detect reflections of the electromagnetic signal and determine a plurality of data points corresponding with the position of reflectors;
a processor configured to receive the plurality of data points from each radar system, and to process the data points to detect and/or track a subject therefrom;
wherein:
each of the radar systems has a boresight, corresponding with an axis of maximum antenna gain for the electromagnetic signal;
the plurality of radar systems comprises a first radar system with a first boresight and a second radar system with a second boresight; and
the first boresight is at an angle of at least 25 degrees to the second boresight.

2. The system of claim 1, wherein the first boresight and the second boresight are at an angle of 25 degrees or less to a horizontal plane.

3. The system of claim 1 or 2, wherein the first boresight and the second boresight are at an angle of at least 45 degrees.

4. The system of any of claims 1 to 3, wherein the plurality of radar systems comprises a radar system with a boresight that is at an angle of less than 45 degrees with a vertical direction.

5. The system of any of claims 1 to 4, further comprising a processor configured to:
receive data points from each of the plurality of radar systems;
for each radar system, define clusters of data points based on the distance between the data points.

6. The system of claim 5, wherein clusters are defined from data points that are within a threshold distance from each other.

7. The system of claim 6, wherein the threshold distance is 15 cm or less.

8. The system of claim 6, or 7, wherein the processor is configured to discard clusters that have fewer than a threshold number of data points.

9. The system of any of claims 5 to 8, wherein the processor is configured to:
transform the data points to a common coordinate system;
define verified clusters comprising clusters from different radar systems that sufficiently overlap in the common coordinate system.

10. The system of any of claims 1 to 9, wherein the processor is configured to classify a cluster as a subject based whether the cluster is sufficiently similar to estimated properties of the subject.

11. The system of any of claims 1 to 10, wherein the processor is configured to:
define a frame comprising data points from the plurality of radar systems with a common time;
clustering data points in each frame to define clusters;
associating clusters in different frames to define a track if a difference in the position of a cluster or group of clusters in different frames is less than a predefined threshold.

12. The system of any of claims 1 to 11, wherein clusters are associated in different frames to define a track where a difference in the position and a difference in the size of a cluster or group of clusters in different frames is less than a predefined threshold.

13. The system of claim 11 or 12, wherein a position of a cluster is defined as the centroid of the data points that comprise the cluster.

14. The system of any of claims 1 to 13, wherein the processor is configured to determine a pose for the subject.

15. The system of any of claims 1 to 14, wherein each of the radar systems comprises a mmWave radar system, and the electromagnetic signal has a frequency of between 75 and 85 GHz.

16. A method for subject detection, comprising:
using a plurality of radar systems, each comprising an antenna, to transmit an electromagnetic signal and to detect reflections of the electromagnetic signal and determine a plurality of data points corresponding with the position of reflectors;
receive the plurality of data points from each radar system, and processing the data points to detect and/or track a subject therefrom;
wherein:
each of the radar systems has a boresight, corresponding with an axis of maximum antenna gain for the electromagnetic signal;
the plurality of radar systems comprises a first radar system with a first boresight and a second radar system with a second boresight; and
the first boresight is at an angle of at least 25 degrees to the second boresight.

17. The method of claim 16, wherein:
i) the first boresight and the second boresight are at an angle of 25 degrees or less to a horizontal plane; and/or
ii) the first boresight and the second boresight are at an angle of at least 45 degrees.

18. The method of claim 16 or 17, further comprising:
receiving data points from each of the plurality of radar systems;
for each radar system, defining clusters of data points comprising points that are within a threshold distance from each other.

19. The method of claim 18, further comprising discarding clusters that have fewer than a threshold number of data points.

20. The method of claim 18 or 19, comprising:
transforming the data points to a common coordinate system;
defining verified clusters comprising clusters from different radar systems that sufficiently overlap in the common coordinate system.

21. The method of any of claims 16 to 20, further comprising classifying a cluster as a subject based whether the cluster is sufficiently similar to estimated properties of the subject.

22. The method of any of claims 16 to 21, comprising:
defining a frame comprising data points from the plurality of radar systems with a common time;
clustering data points in each frame to define clusters;
associating clusters in different frames to define a track if a difference in the position of a cluster or group of clusters in different frames is less than a predefined threshold.

23. The method of any of claims 16 to 22, wherein clusters from different frames may be associated to define a track if a difference in the position and a difference in the size of a cluster or group of clusters in different frames is less than a predefined threshold.

24. The method of claim 22 or 23, wherein a position of a cluster is defined as the centroid of the data points that comprise the cluster.

25. The method of any of claims 16 to 24, further comprising determining a pose for the subject.

26. A method for determining the posture of a subject using a radar system, comprising:
using a radar system to: transmit an electromagnetic signal, detect reflections of the electromagnetic signal, and determine a plurality of data points corresponding with the position of reflectors;
processing the data points to determine the posture of a subject by:
using a part detector to determine an estimate of a position of each of a plurality of joints; and
using a spatial model to refine the estimate of the position of each of a plurality of joints;
wherein the spatial model encodes the expected relative positions between the plurality of joints.

27. The method of claim 26, wherein the part detector comprises a convolutional neural network that has been trained to determine the estimates of the positions of the joints.

28. The method of claim 26 or 27, further comprising performing a temporal correlation operation to smooth the output from the spatial model.

29. The method of claim 28, wherein the temporal correlation operation comprises determining, for each estimated position of a joint: a confidence level, and a speed of movement; wherein the temporal correlation operation rejects updated joint positions in response to the confidence level and/or the speed of movement.

30. The method of any of claims 26 to 29, further comprising a step of determining at least a 2D image from the data points, and providing the 2D image as an input to the part detector.

31. A method of training a system for posture recognition, wherein the system comprises:
a radar system that is configured to transmit an electromagnetic signal, detect reflections of the electromagnetic signal, and determine a plurality of data points corresponding with the position of reflectors;
a part detector for determining an estimate of position for a plurality of joints from the plurality of data points; and
a spatial model, for refining the estimate of the position of each of the plurality of joints from the part detector based on expected relative positions between the plurality of joints;
the method comprising:
i) obtaining ground truth positions of the joints concurrently with detecting reflections of the electromagnetic signal with the radar system;
ii) training the part detector to determine the estimate each joint position from the data points by minimising a first loss function determined with reference to the ground truth positions;
iii) training the part detector to refine the estimate of each joint position from the part detector by minimising a second loss function determined with reference to the ground truth positions.

32. The method of claim 31, wherein step ii) and step iii) are performed sequentially.

33. The method of claim 31 or 32, wherein the training in steps i) and/or ii) comprises performing a gradient descent method.

34. The method of any of claims 31 to 33, in which the training in steps i) and ii) uses a dynamic learning rate of between 10⁻² and 10⁻⁵.

35. A system for determining the posture of a subject using a radar system, comprising:
a radar system configured to: transmit an electromagnetic signal, detect reflections of the electromagnetic signal, and determine a plurality of data points corresponding with the position of reflectors;
a processor configured to process the data points to determine the posture of a subject by:
using a part detector to determine an estimate of a position of each of a plurality of joints; and
using a spatial model to refine the estimate of the position of each of a plurality of joints;
wherein the spatial model encodes the expected relative positions between the plurality of joints.

36. The system of claim 35, comprising a plurality of radar systems, each providing data points to the processor, and the processor configured to use the data points from each radar system to determine the estimate of the position of each joint.

37. The system of claim 35 or 36, wherein the part detector comprises a convolutional neural network that has been trained to determine estimates for the positions of the joints.

38. The system of any of claims 35 to 36, wherein the processor is configured to perform a temporal correlation operation to smooth the output from the spatial model.

39. The system of claim 38, wherein the temporal correlation operation comprises determining, for each estimated position of a joint: a confidence level, and a speed of movement; wherein the temporal correlation operation rejects updated joint positions in response to the confidence level and/or the speed of movement.

40. The system of any of claims 35 to 38, wherein the processor is configured to determine a 2D image from the data points, and provide the 2D image as an input to the part detector.
